(19) United States
(12) Patent Application Publication
(10) Pub. No.: US 2012/0030512 A1
(43) Pub. Date: Feb. 2, 2012

(54) PROVISIONING OF DATA TO A VEHICLE INFOTAINMENT COMPUTING SYSTEM

(75) Inventors: Sukhwinder Wadhwa, Windsor (CA); Michael Raymond Westra, Plymouth, MI (US); Edward Charles Esker, Dearborn, MI (US); Saeid Soleimani, Beverly Hills, MI (US); Henry Heping Huang, Canton, MI (US); Sandeep Waraich, Tecumseh (CA); Timothy Allan Geiger, Saline, MI (US)

(73) Assignee: FORD MOTOR COMPANY, Dearborn, MI (US)

(21) Appl. No.: 12/844,601

(22) Filed: Jul. 27, 2010

(51) Int. Cl. G06F 9/445; G06F 11/14; G06F 11/07

(52) U.S. Cl. 714/23; 717/174; 714/57; 714/E11.025; 714/E11.138

(57) ABSTRACT

Various embodiments include a software provisioning system and method for a vehicle infotainment computer. Software provisioning of the vehicle infotainment computer may occur during vehicle assembly. A software provisioning request may be received for custom installing software to the vehicle infotainment computer. The custom install may be based on a customization schedule which may include a location identifier (such as uniform resource identifiers or file paths) for locating the software. In response to the request, the software may be located on a provisioning server or a portable memory device based on the customization schedule. The software may be transmitted to memory of the vehicle infotainment computer and custom installed on the vehicle infotainment computer.

### BACKGROUND

1. Technical Field

Various embodiments relate to methods and systems for providing volumes of data to a vehicle infotainment computing system. In some embodiments, the volumes of data may comprise software applications.

2. Background Art

Commonly, loading software to a vehicle is performed via a vehicle network (such as a CAN bus).

Examples of various installation methods are offered in the art.

U.S. Pat. No. 6,978,198 issued to Shi (“Shi”) discloses a system and method to load vehicle operation software and calibration data in general assembly and service environment. Shi discloses a data exchange system for use in vehicle assembly which includes a data exchange mechanism exchanging vehicle software and/or diagnostic information between vehicle processors and an external processor. The data exchange mechanism is a portable memory device, such as a USB flash disk, alternately connecting to USB ports of the external processor and the vehicle. Vehicle software is automatically loaded onto vehicle processors by an interface processor connected to a CAN controller, and the processors similarly write back diagnostic information. In another aspect, the data exchange mechanism is a wireless mechanism, such as an iCHIP, connecting the external processor and vehicle processors through a communications network and a CAN controller. Vehicle processors individually wirelessly request appropriate vehicle software and/or provide diagnostic information. The data exchange mechanism may be permanently integrated into the vehicle, or temporarily connected to the vehicle by an alternative connection mechanism, such as the ALDL.

U.S. Publication No. 2006/0130033 to Stoffels, et al. (“Stoffels”) discloses a method for providing a software module to an automotive vehicle control unit, and computer program for executing the method. The method in Stoffels comprises the steps of a) establishing a connection between a programmable memory of the vehicle control unit and a programming device, b) generating a request message, the request message comprising a software module identifier for identifying the software module, c) sending the request message via a communication means to a server, d) receiving from the server an access message, enabling the programming device to access a software module, and e) loading the software module, by the programming device, into the programmable memory.

### SUMMARY

One aspect includes a software provisioning system for a vehicle infotainment computer. A customization schedule may be stored for installing software to the vehicle infotainment computer. The customization schedule may associate a location identifier (such as a URL or a file path) with the software for locating the software for customized installation. In response to a request to custom install software to the vehicle infotainment computer, the software may be located based on the customization schedule and transmitted to memory of the vehicle infotainment computer. The software may be custom installed to the vehicle infotainment computer.

The system may be also be configured to identify the vehicle infotainment computer by receiving a vehicle identification number (VIN) from a vehicle network (such as a CAN bus).

Another aspect may include a software provisioning system for a vehicle infotainment computer which may include a vehicle infotainment computer. A wired or wireless connection may be established with memory (such as a portable memory device or a provisioning server) which stores a customization schedule providing software for customized installation on the vehicle infotainment computer. The customization schedule may associate a uniform resource identifier (URI) with the software. The memory may also include software for customized installation on the vehicle infotainment computer.

The vehicle computer may be further configured to receive the customization schedule from which one or more URIs to receive the software may be obtained. The software may be received from memory based on one or more URIs transmitted to memory. In one embodiment, the URIs may be transmitted as one or more hypertext transfer protocol (HTTP) requests. The software may be custom installed to the vehicle infotainment computer after at least part of the software is received.

The system may also include a software provisioning verification system for error verification in the custom installation. The errors may be diagnostic trouble codes from a vehicle network.

Another aspect includes a method in which input is received for activating software provisioning from a vehicle. A connection is established to a provisioning medium storing a software customization schedule and software for installation on the vehicle computer. Software may be received on the vehicle computer based on the customization schedule and custom installed on the vehicle computer.

In some embodiments, provisioning of the vehicle computer may be performed simultaneously with a configuration of one or more vehicle control modules. Additionally, the provisioning process may occur during vehicle assembly.

The method may also include an interruption handling process for handling provisioning interruptions. In one embodiment, an interruption may be received which triggers the vehicle computer to reboot. The point of interruption during custom install may be determined. After identifying the software provisioning medium, the custom install may be restarted. Alternatively, the custom install may be completed at the point of interruption.

In some embodiments, a determination may be made if the software provisioning medium has changed. If so, the custom install may be restarted.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 is a block topology of a vehicle infotainment system;

FIG. 2 illustrates a software provisioning process in the context of the vehicle infotainment system production process;

FIG. 3 is a block diagram of a software provisioning system, and the operation of the software provisioning system, for a vehicle infotainment system;

FIG. 4 is a software provisioning process according to one embodiment;

FIG. 5 is a software provisioning process according to another embodiment; and

FIG. 6 a process for handling software provisioning interruptions according to one embodiment.

### DETAILED DESCRIPTION

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

Vehicle bus networks (such as CAN) generally cannot handle large volumes of data. For example, at 500 kbps (which is the speed of a high speed CAN), a 120 MB data file may take at least 30 minutes to push across a HSCAN bus. Accordingly, large volumes of data (such as software applications) cannot be loaded to a vehicle infotainment system, such as the SYNC system manufactured by the FORD MOTOR COMPANY, without sacrificing efficiency in the installation process.

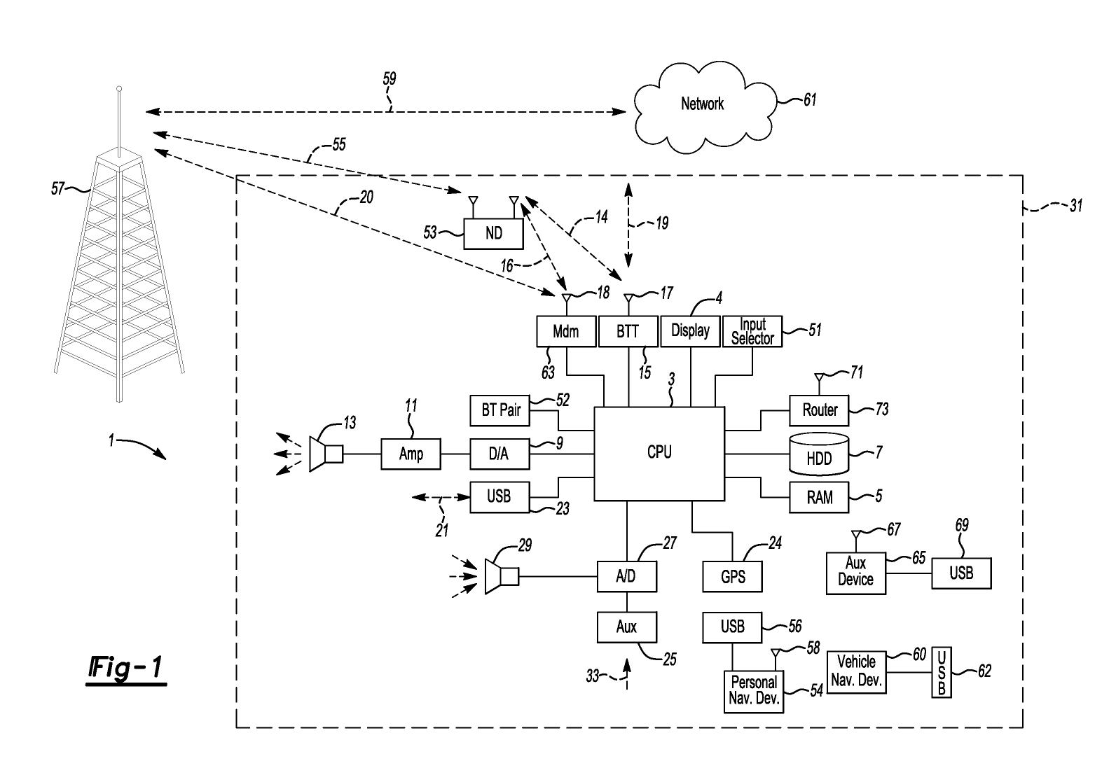

FIG. 1 illustrates an example block topology for a vehicle based infotainment computing system 1 (VCS) for a vehicle 31. It will be appreciated that the disclosure and arrangement of FIG. 1 may be modified or re-arranged to best fit a particular implementation of the various embodiments of the invention. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, etc.). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73.

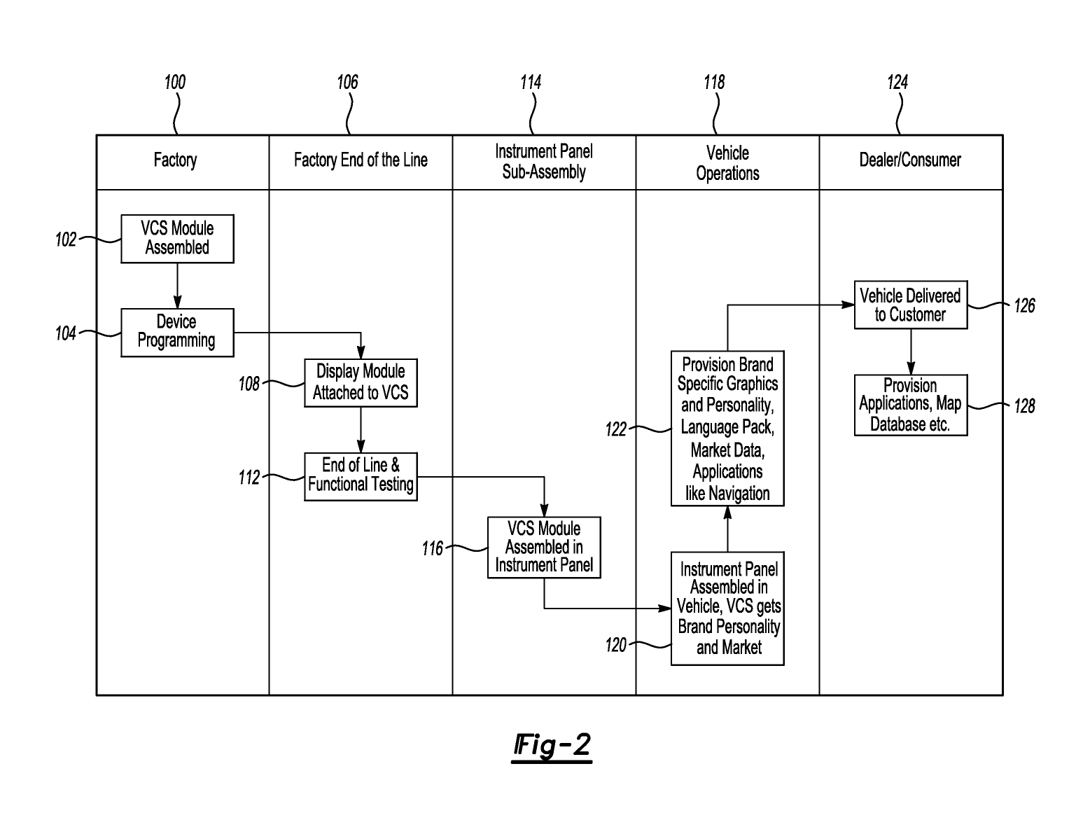

FIG. 2 illustrates a software provisioning process for the VCS 1 during VCS production. It will be appreciated that software provisioning of the VCS 1 may occur at the factory, at the dealership, and/or post-sale of the vehicle. Further, software provisioning may be performed on the assembly line, by a dealer, and/or by the vehicle owner. As such, FIG. 2 may be modified or re-arranged to best fit a particular implementation of the various embodiments of the invention.

The software provisioning process for the VCS 1 may be optimized for efficiency such that volumes of data, large or small, may be installed. In one non-limiting example, the provisioning system and process may be configured to push 180 MB-270 MB of data within about 5 minutes which translates to a range of between 1-1.2 MB per second. It should be understood that this example is provided for illustration only and, therefore, is non-limiting. Accordingly, file sizes and data transfer rates may differ based on the specific implementation of the system and environmental factors associated with the data transfer.

The provisioning system and process may also be scalable. As such, one provisioning system may be used for multiple VCS that may be configured on the assembly line.

Referring now to FIG. 2, the VCS assembly and provisioning process is illustrated and described. Of course, other vehicle and VCS assembly processes may be implemented. FIG. 2 may represent the “assembly line” production of the VCS 1. In this example, the VCS 1 may be assembled (block 102) in the factory 100 and programmed (e.g. “image flashing”)(block 104). When the end-of-the-line 106 is reached, the display module 4 may be attached to the VCS 1 (block 108) and end-of-the-line testing and functional testing may then be performed (block 112).

During the instrument panel sub assembly 114 process, the VCS 1 assembly may be assembled (block 116) to the instrument panel of the vehicle. During the vehicle operations 118 process, the assembled instrument panel may then be assembled in the vehicle (block 120). During this phase, the VCS 1 may receive brand personality. For example, a splash screen may be programmed to display the “Ford” name and logo for a Ford vehicle. Further, the VCS 1 may be provisioned with brand specific graphics, language packs, market data and other software applications (such as navigation) (block 122).

The vehicle may be delivered from the factory to the dealership 124. The customer may purchase and receive the vehicle from the dealership (block 126). Further software provisioning may occur of other applications, a map database, and other VCS 1 software (block 128).

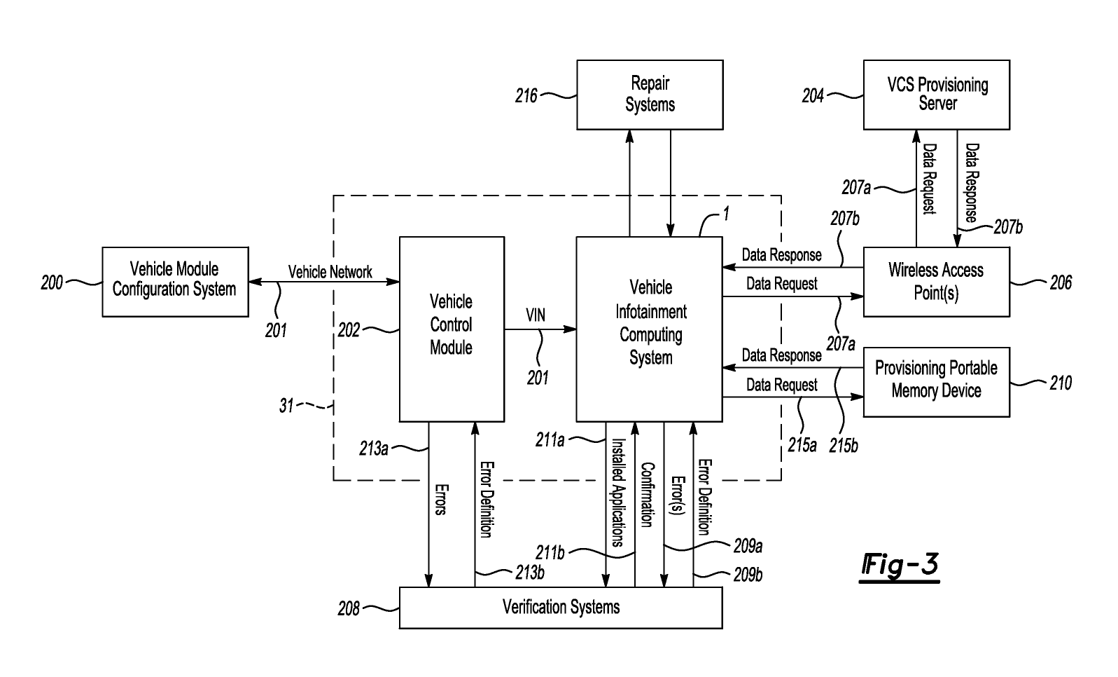

FIG. 3 is a block diagram of the system architecture and operation of a software provisioning system for the VCS 1. It will be appreciated that the disclosure and arrangement of FIG. 3 may be modified or re-arranged to best fit a particular implementation of the various embodiments of the invention.

One or more vehicle modules 202 may be configured over a vehicle network such as a CAN network 201. In this context, vehicle modules refer to vehicle control modules including, but not limited to, the powertrain control module (PCM), engine control unit (ECU), the airbag control module (ACM), and other like vehicle control modules. Configuration of the vehicle modules may be performed by a vehicle module configuration system 200 in the vehicle production line. The configuration process of the vehicle modules may occur before software provisioning of the VCS 1. However, it will be appreciated that the configuration process, or at least part of it, may occur later without departing from the scope of the various embodiments. In one embodiment, vehicle module configuration and the software provisioning may be performed simultaneously.

The VCS 1 may utilize a vehicle identification number (VIN) for its software provisioning. The VIN may be received over a CAN network 201 by the VCS 1 to identify the vehicle and the VCS being provisioned.

With the VIN and a constant power supply to the VCS 1, the software provisioning process may be accomplished with the aid of a software provisioning server 204. The server 204 may provide the information for provisioning the VCS 1 which may be stored in memory of the server 204 and/or a provisioning database (not shown). The information may include, but is not limited to, software applications for installation to the VCS 1 and instructions defining the software set for installation on the VCS. The set may include one or more software applications or data sets. In one embodiment, these instructions may be a software bill of materials (BOM) (these instructions will generally be referred to herein as a “BOM”). In one embodiment, the BOM may be stored on the server as a text file and may be identified by a VIN. This text file may also be referred to as the “provisioning source” for the VCS 1. As an example, the BOM may be in a file on the server called <VIN>.lst where “VIN” refers to the vehicle's VIN. In some instances, a VIN may not be available over the vehicle network during provisioning. In this case, a default VIN, or other default identification number, may be used.

A VCS 1 in every vehicle may be individually provisioned. Accordingly, the VCS 1 may receive customized packages or customization schedules during the provisioning process. The customization schedule may be included in the provisioning source. In one embodiment, the customization schedule may be the software bill of materials. The customization schedules may be based on a build schedule for the vehicle. The build schedule may include, but is not limited to, country/region of destination (i.e., language packs), brand of the vehicle, trim level (e.g., and without limitation, size of interior displays), presence of certain features (e.g., and without limitation, emergency response, vehicle health reports, etc.), and application licensing. The customization schedule may further be based on preferences and/or requirements of a customer, OEM, dealer, and the like.

The VCS 1 may communicate with the server 204 through one or more wireless access points 206. Where there are multiple access points 206, the VCS 1 may arbitrarily choose an access point 206 with which to communicate. In some embodiments, the decision may be based on performance issues of the access points 206 (such as load balancing). Wireless communication between the VCS 1 and the server 204 may include, but is not limited to, WiFi (or other wireless communication based on the 802.11 standard), BLUETOOTH, and other like wireless technologies.

Of course VCSI and VCS provisioning server 204 may also be connected via hard wire data connection such as Ethernet, RS-232, USB or the like. Performance of the provisioning process may also be affected by the speed of the assembly line, speed of software download, position of the access points, and power levels. Accordingly, the VCS 1 may also support roaming between access points during software download.

In one embodiment, the access point(s) may be dedicated to software provisioning. For example, and without limitation, the access points may be identified with the name “SYNCPROV0” or “SYNCPROV1” which may refer to “Sync Provisioning.” It will be appreciated that the access point name may or may not be case sensitive. Further, the service set identifier (SSID) of the access point may or may not be single-case or mixed-case. As an example of the case sensitivity of the access point, an SSID with upper case letters may permit VCS provisioning while mixed-case or lowercase SSID may not.

The access point(s) 206 may include a timeout period. As such, if a connection has not been made within the timeout period, a connection may be retried. If there are multiple access points 206, a connection with a new access point 206 may be attempted. In some embodiments, the timeout period may be 20 seconds.

The VCS 1 may exchange data with the server 204 using HTTP requests 207a and responses 207b. Other protocols may be utilized, but HTTP will be used herein for purposes of illustration. The other protocols may include, but are not limited to, TFTP, FTP, POP, RSYNC, SCP, and SSH. Further, SSL may be used in combination with any of these protocols for secure transmission.

These HTTP requests 207a may include (singly or in combination) a URI (Uniform Resource Identifier) of the provisioning source, the VIN, or an electronic serial number (ESN) of the VCS 1. The URI may be used to receive instructions defining the software set for installation (which may be a bill of materials) on the VCS 1. The VIN may be used to identify the vehicle. The ESN may be used to identify the VCS 1.

The data requested from the server 204 through the HTTP request 207a may include, but is not limited to, the instructions defining the software set for installation (identified by VIN) and application(s). As such, software provisioning of the VCS 1 may be performed via application installation. Applications may include, but are not limited to, branding applications (that define the brand of the vehicle), region/language applications (customizing the VCS 1 to the particular geographical region), display applications, graphics applications, data manager applications, application license(s) and licensing keys, and service packs.

In some embodiments, some applications (e.g., and without limitation, application licenses) may be installed via transient applications. These transient applications may be run once and then deleted from the VCS 1.

The responses 207b from the server 204 may include the provisioning source (i.e., the <VIN>.lst file) and the application(s) requested from the server 204. The software application(s) may be associated with a part identifier which may comprise a part of the address of the URI for retrieving the software. The part identifier may be pre-defined by an OEM.

Verification systems 208 may be used to verify that software installed to the vehicle 31 has been successfully installed. Verification may include examining the results of the provisioning of the VCS 1 for errors and/or verifying installation of software. In some embodiments, verification testing may also include verifying 213a,b the results of the configuration of the vehicle control modules 202. Verification systems 208 may include terminals (e.g., portable and non-portable devices), databases, and/or software for performing the verification testing. Further, verification system 208 may or may not be installed on the VCS 1. In one embodiment, verification testing may occur at the end of the production line.

During the software provisioning process, the VCS 1 may collect and record errors that occurred during the provisioning process. In one embodiment, these errors may be diagnostic trouble codes (DTCs). At a predetermined time, and/or at certain time intervals, the errors may be transmitted 209a to the verification system 208 for diagnosis. A diagnosis may include receiving the error(s) and determining the software provisioning fault associated with the error.

The errors may be received from the VCS 1 as a string of characters. When the verification system 208 receives the error(s), it may define the error based on a look up of a table having the software provisioning faults. The faults may be in a user-comprehensible form. As an example, the VCS 1 may transmit 209a to the verification system 208 “DTC XXXXX” where the X's represent numbers and/or letters. The verification system 208 may define this error based on a look up of the faults table and determine the definition of this error.

The verification system 208 may transmit 209b the defined error to the VCS 1 which may output the definition to the user. An output may be audible and/or visual. For example, the diagnosis may be output as speech, a series of beeps or tones, text on the display 4, and/or graphical images on the display 4.

Non-limiting examples of errors include, but are not limited to, missing/unavailable BOM, missing/unavailable application(s), unprovisioned VCS, installing software application(s) that already exists on the VCS 1, application(s) fail to install, and/or insufficient memory to install application(s). Based on the error(s), the VCS 1 may be re-provisioned to clear the error(s) from the VCS 1.

Verification system 208 may additionally or alternatively verify installation of the application(s). An installed application may include one or more installation identifiers which may be used to verify the installed application(s). In one embodiment, the installation identifiers may be associated with a group of installed applications (e.g., one identifier may be associated with a group of one or more installed applications). Accordingly, a receipt of the installation identifier will indicate to the verification system 208 the group of applications that have been installed. In one embodiment, the installation identifiers may be transmitted to the verification system 208 over the vehicle network.

The verification process may occur at certain time intervals during the provisioning process or at a single predetermined time (e.g., and without limitation, once provisioning is complete). During verification, the installation identifier(s) may be received 211a by the verification system 208 from the VCS 1 and the information recorded in the verification system 208. In one embodiment, this information may be tracked to determine the state of the VCS 1. A confirmation of the installed applications may or may not be transmitted 211b back to the VCS 1.

The provisioning process may be additionally or alternatively performed with a portable memory device 210. A portable memory device 210 may include, but is not limited to, a USB stick, a secured digital (SD) card, a compact flash (CF) card, and an external hard drive. Further, the portable memory device may be wired or wireless. The VCS 1 may comprise a port for receiving memory cards such as SD and CF cards.

When the portable memory device is received by the VCS 1, the provisioning source may be requested 215a and received 215b by the VCS 1 from the portable memory device 210. The provisioning source may be stored as a text file in the root directory of the portable memory device 210. For example, and without limitation, the provisioning source may be called <VIN>.lst.

The URIs defined in the BOM for accessing software application may define file paths on the portable memory device 210. As with wireless provisioning described above, the software applications may be received according to the BOM and installed on the VCS 1. Any provisioning errors that are collected and recorded may be defined and/or verified with the verification system 208.

In one embodiment, wireless provisioning systems or the portable memory device 210 may be used for software provisioning if any part of the provisioning failed. In this case, repair systems 216 may be utilized in repairing the failed part(s). Repair system 216 may additionally or alternatively be used when a VCS 1 is replaced with an unprovisioned VCS.

Repair system 216 may include systems for provisioning the VCS 1. In one embodiment, software may be manually installed by a user using repair system 216. When the provisioning process has failed, a repair may be initiated based on the receipt of an error during the wired or wireless provisioning process.

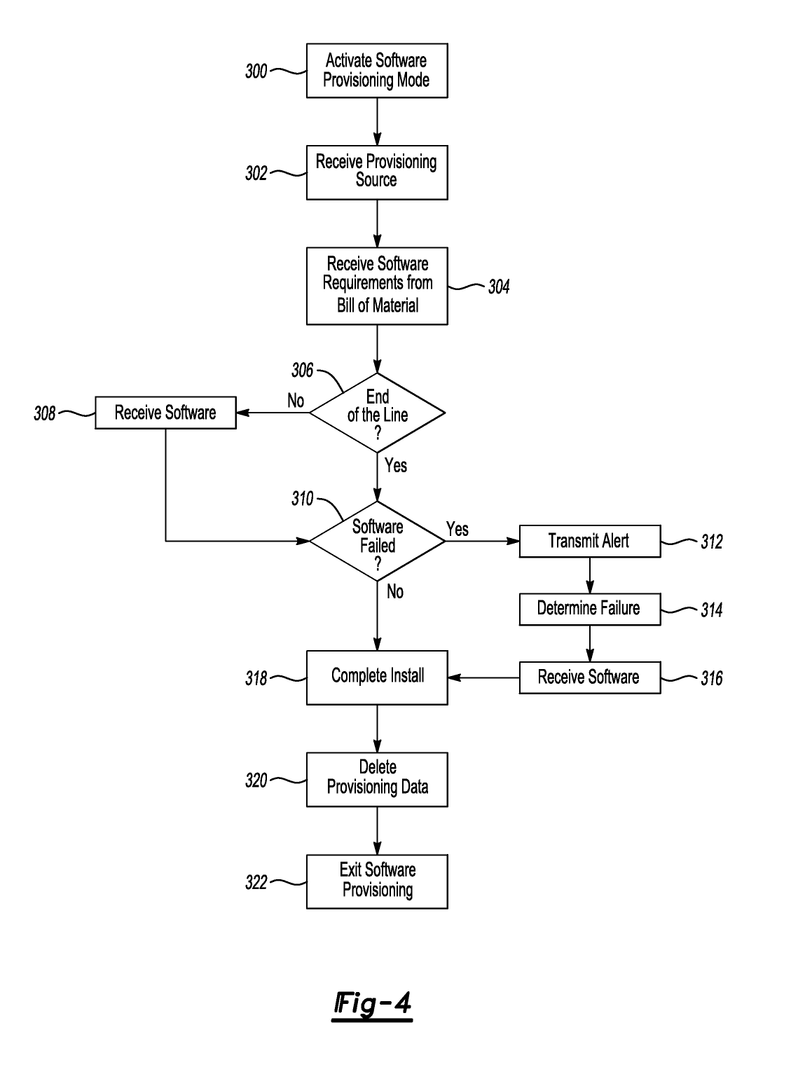

FIG. 4 illustrates a software provisioning process according to one of the various embodiments. It will be appreciated that the disclosure and arrangement of FIG. 4 may be modified or re-arranged to best fit a particular implementation of the various embodiments of the invention.

The provisioning process may be activated with an activation input (block 300) which activates a software provisioning mode of the VCS 1. The activation input may be automatic and/or manual. An automatic activation input may be a signal from the vehicle network. In this case, the VCS 1 may include a provisioning routine (which may or may not be a diagnostic routine programmed to the VCS 1) which, when run, automatically activates software provisioning. A manual activation input may be an audible (e.g., voice command) and/or a tactile (e.g., touchscreen input) input in the vehicle. Additionally, the process may be activated in response to the insertion of a portable memory device.

The VCS 1 may identify when it has or has not been successfully provisioned based on a provisioning identifier stored in non-volatile memory of the VCS 1. For example, a “0” may indicate that the VCS 1 is unprovisioned and a “1” may indicate that the VCS 1 is provisioned. In one embodiment, a security feature may be in place that prevents the provisioning identifier from being changed after the VCS 1 has been provisioned. This security feature may survive a reprogramming (or re-flash) of the VCS 1 (block 104, FIG. 2). It will be appreciated that the identifier may be numeric, alphabetic, or alphanumeric.

The provisioning source (e.g., a <VIN>.lst file) may be received by the VCS 1 (block 302). The software installation schedule from the BOM contained in the provisioning source may be extracted and read for determining which software to install on the VCS 1 (block 304).

Provisioning may occur during vehicle production. Therefore, a VCS 1 that has not been at least partially provisioned by the end of the production line will result in this error being detected. As such, if the VCS 1 is partially or fully unprovisioned, a determination may be made whether the end of the production line has been reached (block 306). If not, the software may be received/downloaded according to the build schedule in the BOM (block 308).

When the software has been received, a determination may be made whether there is a software failure (block 310). A software failure may be due to an error received during software provisioning. Non-limiting examples of errors are described above. If the end of the line has been reached, it may also be determined if a software failure exists (block 310).

If a failure is found, an alert may be transmitted from the VCS 1 (block 312). The alert may be audible and/or visual (i.e., textual and/or graphical). The software failure may then be determined from the error alert (block 314). In response to the error alert, software may be received to repair the error (block 316).

The software that is received by the VCS 1 may be installed (block 318). Software download and software installation may or may not be simultaneous. Further, multiple installations of different software may or may not occur simultaneously.

In one embodiment, when the software installation process is complete (whether based on an error or not) (block 318), data on the VCS 1 that is utilized in the provisioning process may be deleted from memory. This may include connection data to the wireless or wired device (e.g., server 204 or a USB stick) (block 320). For example, and without limitation, in the case of wireless provisioning, data relating to any wireless (e.g., WiFi) connections and wireless keys may be deleted. This may be used to prevent later re-provisioning of the VCS 1.

Once the provisioning process completes with installation (block 318), the software provisioning mode of the VCS 1 may be exited and terminated (block 322). This mode may or may not be accessed again after software provisioning is complete.

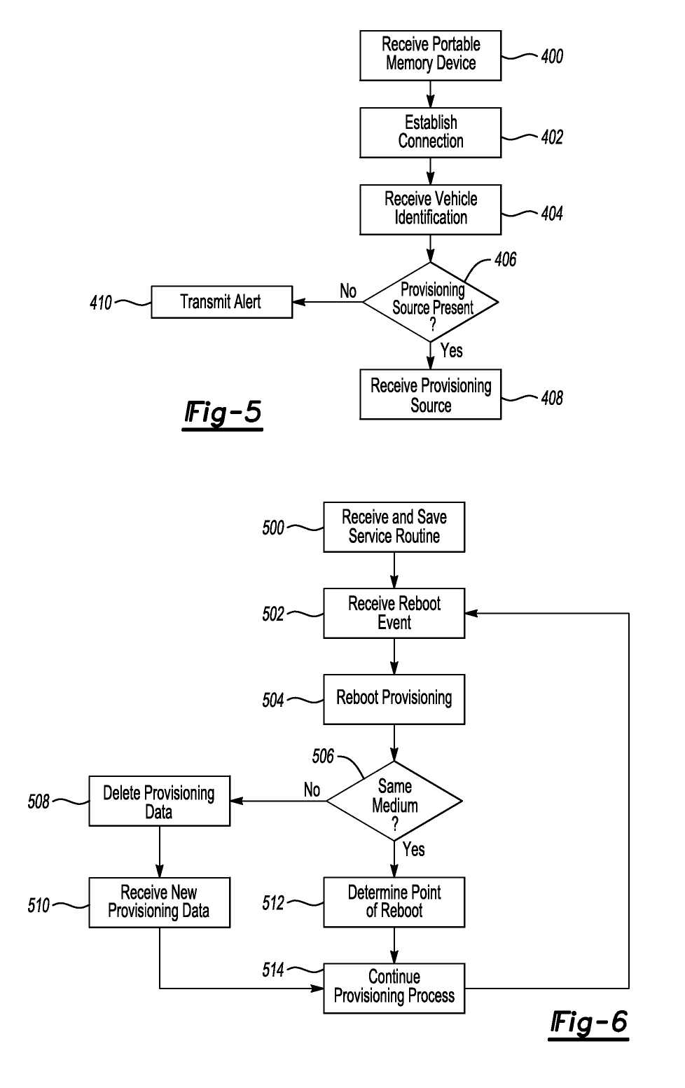

Software provisioning may be performed additionally or alternatively with a wired device such as a portable memory device. In some embodiments, a wired device may be used for manual software provisioning. FIG. 5 is a provisioning process when using a wired device. It will be appreciated that the disclosure and arrangement of FIG. 5 may be modified or re-arranged to best fit a particular implementation of the various embodiments of the invention.

The portable memory device may received as input at a port of the VCS 1 (block 400). As a non-limiting example, a USB memory stick may be inserted into the USB port of the VCS 1. Once received, a connection may be established between the portable memory device and the VCS 1 (block 402).

The VIN may be received from the vehicle network (block 404) which may be used to search for the provisioning source on the portable memory device. As described above, the provisioning source may be saved as a text file in the root directory on the portable memory device.

If the provisioning source is found (block 406), the provisioning source is received by the VCS 1 (block 408) and installation of the software can be accomplished as described above. If the provisioning source is not present, an alert may be transmitted on the VCS 1 indicating this error (block 410). The error alert process is described above with respect to FIG. 4.

The status of the provisioning may be presented to the user during the provisioning process. The status may be audible (e.g., speech-based) and/or visual (e.g., graphical and/or textual). The status may be presented automatically (e.g., at predetermined time intervals) and/or in response to a manual input (e.g., as a result of a voice command or tactile input in the vehicle). The status may include, but is not limited to, the progress of each software package installed, an overall status (e.g., provisioning is complete or not complete), elapsed provisioning time, time left for completion, wireless signal strength, IP address, the SSID of the of the access point, and error(s) encountered.

FIG. 6 illustrates a reboot handling process of the software provisioning process. The provisioning routine (described above) may be used as part of the reboot process. As such, the provisioning routine may be received and saved on the VCS 1 (block 500). In one embodiment, this routine may be received when provisioning begins.

A reboot may occur due to the installation of a service pack. Additionally or alternatively, a reboot may occur due to an interruption in the provisioning process (an interruption may be due to, for example, a power loss). These may be referred to as a “reboot event.” During the provisioning process, a reboot event may be received by the VCS 1 (block 502).

When the reboot event is received, the VCS 1 may be rebooted and the provisioning process restarted (block 504). Rebooting may occur immediately or after a predetermined time. A predetermined time may be a certain lapse of time and/or the installation of some or all software applications. When the reboot is due to an interruption, during the predetermined time, the VCS 1 may attempt to re-establish a connection. In one embodiment, a reboot may occur only a predetermined number of times at which point an error may be reported and the provisioning process terminated.

The provisioning process may be restarted from the beginning. Alternatively, the provisioning process may be restarted from the point where the interruption occurred. This may be so that the portions of the process that are complete are not repeated and/or installation may complete (e.g., when a service pack is installed).

The provisioning system may be capable of handling a change in the provisioning medium during provisioning (e.g., wireless provisioning to wired provisioning or using two different portable memory devices). For example, when an interruption occurs, the user may continue provisioning after the interruption from a different provisioning medium than with which provisioning was started. The VCS 1 may make a determination then if the same medium is being used when the reboot occurs or when the provisioning process is restarted (block 506). The determination may be made based on the provision medium from where the provisioning source was originally received.

If a new medium is used, the BOM from the previous provisioning medium may be deleted (block 508) and the BOM from the new provisioning medium received (block 510). The provisioning process may proceed with the BOM from the new provisioning medium (block 514).

If the same medium is being used, the point of reboot may be determined (block 512) so that provisioning may restart from that point if provisioning is not complete. If further provisioning remains, provisioning may then continue from the point of reboot (block 514).

It will be appreciated that the various embodiments of the methods and systems are described in the context of provisioning the VCS 1 with software applications. However, the provisioning system and method may be used in other contexts such as programming or re-programming (i.e., flashing or re-flashing) of the VCS 1. In all cases, the various embodiments may enable creating different permutations of the VCS 1 without physically generating different combinations of modules and software. As such, multiple VCS 1 modules may be provisioned differently while reducing the number of tools utilized in the provisioning process. This may be useful where, as one example, an OEM owns three different vehicle brands (X, Y, and Z) and each brand may be made for 20 different regions. Further, some of these brands may include navigation systems. Therefore, different combinations of modules do not need to be created to meet these requirements for each vehicle in each brand.

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

What is claimed:

1. A software provisioning system for a vehicle infotainment computer, the software provisioning system being configured to:
store a customization schedule for installing software to a vehicle infotainment computer;
receive from the vehicle infotainment computer a software provisioning request to custom install software to the vehicle infotainment computer;
in response to the request, locate the software based on the customization schedule; and
transmit the software to memory of the vehicle infotainment computer for customized installation.

2. The software provisioning system of claim 1 wherein the customization schedule has a software location identifier for locating each software for customized installation.

3. The software provisioning system of claim 2 wherein the system is further configured to receive the software location identifier for retrieving the software for customized installation.

4. The software provisioning system of claim 3 wherein the software location identifier is a uniform resource locator (URL) or a file path.

5. The system of claim 1 wherein the system is further configure to receive a vehicle identification number (VIN) that identifies the vehicle infotainment computer.

6. The system of claim 5 wherein the VIN is associated with the customized schedule and the system is further configured to retrieve the customization schedule for the vehicle infotainment computer based on the VIN.

7. The system of claim 5 wherein the VIN is obtained by the vehicle infotainment computer from a vehicle network.

8. A software provisioning system for a vehicle infotainment computer, the system comprising:
a vehicle infotainment computer configured to:
establish a connection with memory storing a customization schedule comprising software for customized installation on the vehicle infotainment computer and the software for customized installation on the vehicle infotainment computer, the customization schedule associating a uniform resource identifier (URI) with each software;
receive from memory the customization schedule;
obtain from the customization schedule one or more URIs to receive the software;
transmit the one or more URIs to memory;
receive the software from memory based on the one or more URIs; and
custom install the software to the vehicle infotainment computer after at least part of the software is received.

9. The system of claim 8 wherein the memory is a portable memory device.

10. The system of claim 8 wherein the memory is a software provisioning server.

11. The system of claim 8 wherein the software comprises a large volume of data.

12. The system of claim 8 wherein the system further comprises a software provisioning verification system configured to:
receive diagnostic trouble codes defining an error in the custom installation; and
presenting the error at the vehicle infotainment computer.

13. The system of claim 12 wherein the vehicle infotainment computer is further configured to:
receive the diagnostic trouble codes from a vehicle network; and
transmit the diagnostic trouble codes to the software provisioning verification system.

14. The system of claim 8 wherein the customization schedule is based on at least one of a geographic region, user preferences, licensing, OEM preferences, or vehicle type.

15. The system of claim 8 wherein the connection is a wireless or wired connection.

16. The system of claim 8 wherein the vehicle infotainment computer is further configured to transmit the one or more URIs as one or more hypertext transfer protocol (HTTP) requests.

17. The software provisioning system of claim 3 wherein the URI is a uniform resource locator (URL).

18. A method comprising:
receiving input for activating software provisioning from a vehicle;
connecting to a provisioning medium storing a software customization schedule and software for installation on the vehicle computer;
receiving from the provisioning medium the software based on the customization schedule; and
custom installing the software on the vehicle computer.

19. The method of claim 18 further comprising performing the method simultaneously with configuration of one or more vehicle control modules.

20. The method of claim 18 wherein the method is performed during vehicle assembly.

21. The method of claim 18 further comprising:
receiving an interruption triggering the vehicle computer to reboot;
determining a point of interruption during custom install;
after the reboot, identifying the software provisioning medium; and
after identifying the software provisioning medium, restarting the custom install or completing the custom install at the point of interruption.

22. The method of claim 21 wherein identifying the software provisioning medium further includes:
determining if the software provisioning medium has changed; and
if the software provisioning medium has changed, restarting the custom install.

23. The method of claim 18 wherein the input is a signal from a vehicle network.

24. The method of claim 18 further comprising maintaining a connection to the provisioning medium by roaming between access points.

25. The method of claim 18 further comprising prohibiting software provisioning upon completion of a custom install.
